(19) United States
(12) Patent Application Publication
(10) Pub. No.: US 2024/0387115 A1
(43) Pub. Date: Nov. 21, 2024

(54) HIGH POWER DENSITY CAPACITOR

(71) Applicant: Weinberg Medical Physics, Inc., North Bethesda, MD (US)

(72) Inventors: Irving N. WEINBERG, Chevy Chase, MD (US); Lamar Odell MAIR, Baltimore, MD (US)

(21) Appl. No.: 18/668,633

(22) Filed: May 20, 2024

Related U.S. Application Data
(60) Provisional application No. 63/541,018, filed on Sep. 28, 2023.
(60) Provisional application No. 63/467,743, filed on May 19, 2023.

(51) Int. Cl. H01G 4/38; H01G 13/00

(52) U.S. Cl. CPC H01G 4/385; H01G 13/00

(57) ABSTRACT

An apparatus and method of making the apparatus are provided having a plurality stacked undulating layers having an undulation pattern forming a patterned capacitor. At least one of the plurality of layers includes sublayers of dielectric material materials and electrically conducting materials.

### CROSS-REFERENCE AND PRIORITY CLAIM

This application claims priority to U.S. Provisional Patent Application Ser. No. 63/467,743, entitled “HIGH POWER DENSITY CAPACITOR” filed May 19, 2023, and U.S. Provisional Patent Application Ser. No. 63/541,018, entitled “ENERGY TRANSPORT THROUGH DELIVERY OF CHARGED HIGH POWER DENSITY CAPACITORS” filed Sep. 28, 2023 the entirety of each is incorporated by reference.

### FIELD

An apparatus and method are provided for constructing and using high power density capacitors.

### BACKGROUND

The power density of a fast-discharging capacitor increases with increasing surface area, with decreasing dielectric thickness, and higher voltage-handling capability.

### SUMMARY

An apparatus and method of constructing high power density capacitors are provided. The apparatus may comprise a plurality stacked undulating layers having an undulation pattern forming a patterned capacitor, and at least one of the plurality of layers including sublayers of dielectric material materials and electrically conducting materials.

The method may include the patterning and layering of wafers with rounded edges, each wafer including conducting and dielectric sections.

The method may further include forming stacks of the layers via the sequential application of pressure, applied over a 3D printed shape-defined mold having an undulation pattern.

An apparatus for manufacturing a patterned capacitor may be provided having at least one pressure controlled motorized embossing tool configured to press an embossing mold into a film surface for patterning films. The apparatus may be used to sequentially stack material films layer by layer for forming a capacitor.

An apparatus and method of transporting energy are provided by physically moving charged high-energy-density capacitors to one or more locations where the energy is needed.

### BRIEF DESCRIPTION OF THE FIGURES

FIG. 1 shows an embodiment of a high density capacitor apparatus;

FIG. 2 illustrates a flowchart of a method employed to construct a capacitor in accordance with the disclosed embodiments;

FIG. 3 illustrates an alternative method employed to construct a capacitor in accordance with the disclosed embodiments;

FIG. 4 illustrates some of the method of construction of the disclosed embodiments in a mold;

FIG. 5 illustrates how the layers constructed one-by-one in FIG. 4, each layer comprising a sub-capacitor, may be assembled into a capacitor;

FIG. 6 illustrates an embodiment of a manufacturing assembly for carrying out the methods of the disclosed embodiments for construction of the apparatus;

FIGS. 7 and 8 illustrate an embodiment of a method of constructing sub-capacitors (shown as wafers) that do not require a mold.

FIG. 8 further illustrates the method processing and attaching sub-capacitors to form a capacitor as described in the disclosed embodiments; and

FIG. 9 shows an embodiment of the method transporting energy according to the disclosed embodiments.

### DETAILED DESCRIPTION

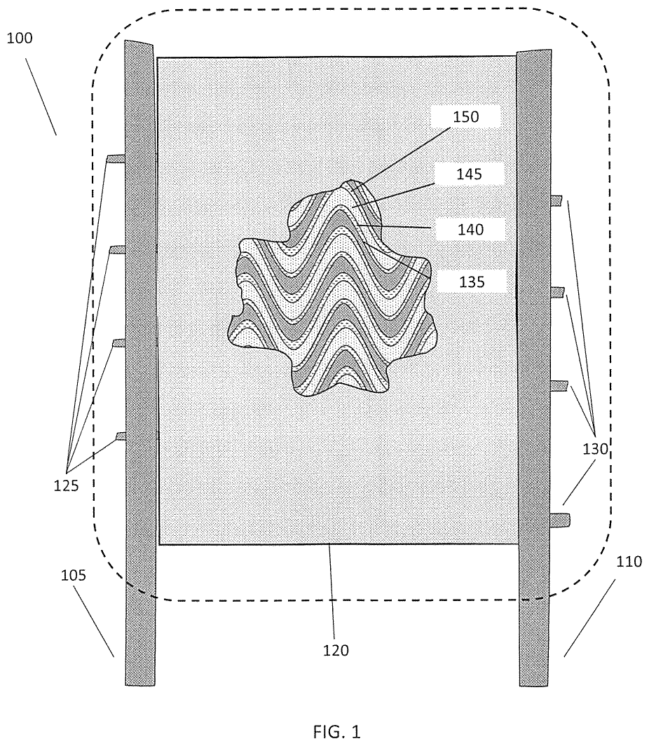

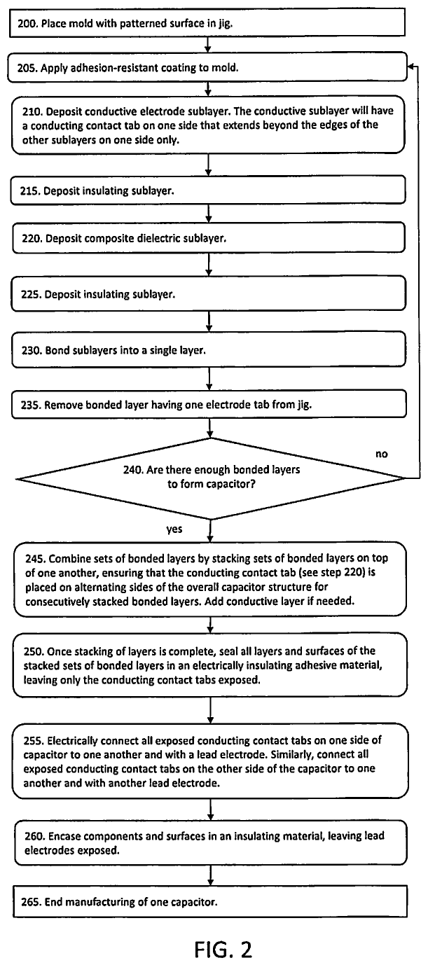

Disclosed embodiments reference an apparatus in FIG. 1 and method for patterning and assembling capacitors in FIGS. 2-8. The apparatus may contain layers consisting of sublayer components such as electrodes, insulators, and dielectric materials. The layers and sublayers may have physical features (e.g., undulating surfaces and aspect ratios) that may be specified within tens of microns or smaller.

As illustrated in FIG. 1, from the outside in of the apparatus, a housing 100 may surround most of the capacitor, with the exception of terminal electrodes 105, 110. An insulating material 120 may cover internal parts of the capacitor. Contacts 125, 130 connect terminal electrodes 105, 110 to internal parts of the capacitor. For illustrative purposes only, a cutout in 120 reveals internal details of the capacitor. The capacitor contains multiple layers, with each layer being composed of multiple sublayers. A representative layer in an embodiment includes an electrically conductive sublayer 135, an electrically insulating sublayer 140, a composite dielectric sublayer 145, and another electrically insulating sublayer 150. In some embodiments, the wavy pattern of the sublayers (and layer) may be reproduced in the dimension perpendicular to the plane of the Figure. In some embodiments, voids and gaps may be introduced between sublayers and/or layers to allow entry of coolant materials (e.g., air, heat-conducting plastics). In some embodiments, the apparatus' largest dimension is more than 1 mm, or more than 5 mm, or more than 10 mm, or more than 100 mm.

It is understood that the capacitance of the FIG. 1 apparatus is increased as the dielectric constant of the dielectric sublayer 145 increases, as the aspect ratio of the undulating pattern of the dielectric and other sublayers increases because of the resultant increase in effective area, and as the distance between the electrically conducting sublayers 135 decreases. In some embodiments, the distance between the conducting sublayer layers may be less than 1 micron, less than 10 microns, or less than 20 microns.

It is understood that the ability to withstand high voltages may be improved by having insulating sublayers 140 with high dielectric strength, and by selecting a composite dielectric sublayer 145 that includes a material with high dielectric strength, for example poly (vinylidene fluoride). For the purposes of this disclosure, the aspect ratio may be more than one, more than 5, or more than 10. It is understood that the overall resistance of the invention will be decreased (i.e., improved) by using electrically conductive sublayers with high electrical conductivity, or which may be coated with materials that have high electrical conductivity.

MXene is one exemplary dielectric material with high dielectric constant, as taught by S. Tu et al in the 2018 ACS Nano publication entitled “Large Dielectric Constant Enhancement in MXene Percolative Polymer Composites”. Dielectric material sublayer 455 may be less than 50 microns, or less than 20 microns, or less than 10 microns in thickness.

PVDF is one exemplary insulating material, with a dielectric strength quoted as high as 800 kV/mm, as taught by M Hikita et al in the 1980 J Phys D (Applied Physics) publication entitled “Dielectric breakdown and electrical conduction of poly (vinylidene-fluoride) in high temperature region”.

Additional features, such as attachments, on the surface of the capacitor (e.g., handles, mounting brackets) may be added to the capacitor to enable or facilitate travel by truck, rail, container, sea, or airplane. Additional features for connecting capacitors to each other or to a facility or to a vehicle or other consumer of electricity, e.g., boost or step-down circuits, may be added to the capacitor.

A method of constructing a capacitor in accordance with the disclosed embodiments is illustrated in FIG. 2. A mold with a patterned surface may be placed in a jig 200 and adhesion-resistant coating may be applied to the mold 205. A conductive electrode sublayer may be deposited in the mold 210. Insulating sublayer may be deposited 215, followed by composite dielectric sublayer 220, and another insulating sublayer 225. All of the deposited sublayers may be bonded to form a single layer 230. The conductive sublayer may have a conducting contact tab on one side that extends beyond the edges of subsequently deposited sublayers on one side only. The bonded sublayers may form a bonded layer, or wafer, with one electrode conducting contact tab that may be removed from the jig 235. A determination is made whether there are sufficient bonded layers to form a capacitor 240. If not, operations 205-235 may be repeated to form one or more additional bonded sublayers. If a determination is made that there are enough bonded sublayers to forma capacitor 240, then sets of bonded layers may be combined by stacking the sets of bonded layers on top of one another while ensuring the conducting contact tab in each bonded layer is placed on alternating sides of the overall capacitor structure for consecutively stacked bonded layers 245. A conductive layer may optionally be added to the stack. All layers and surfaces of the stacked sets of bonded layers may be sealed in an electrically insulating adhesive material so that only the conducting contact tabs are exposed 250. All exposed conducting contact tabs on one side of the capacitor are electrically connected with each other via a lead electrode. Similarly, all exposed conducting contact tabs on the other side of the capacitor may be electrically connected to one another via a lead electrode 255. Components and surfaces may be encased in an insulating material that leaves the lead electrodes exposed 260, thereby ending the manufacturing of a capacitor 265.

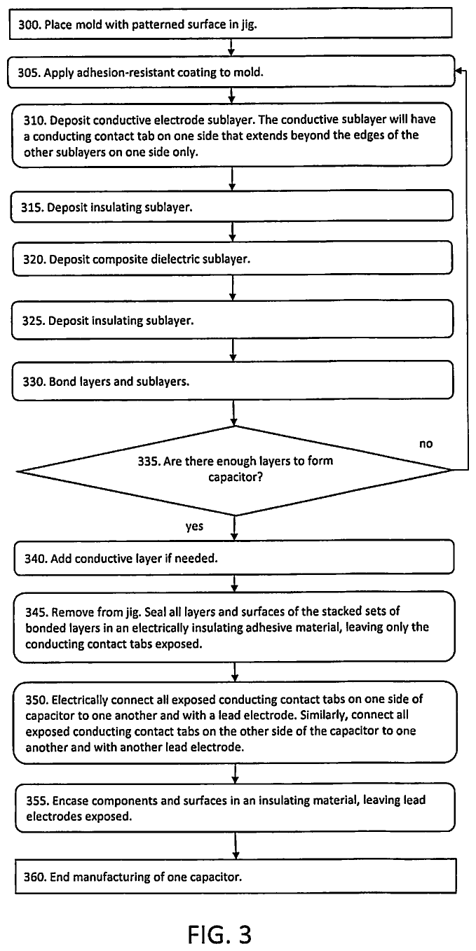

In this and subsequent FIGS. 3-5, it is understood that additional processing steps may be included but are not shown (for example heating of the dielectric layer to obtain optimal electrical properties). The method shown constructs layers one at a time, and then binds the layers together into a single functional capacitor.

A method of constructing a capacitor in FIG. 3 constructs layers on top of one another, and then binds the layers together into a single functional capacitor. A mold with a patterned surface may be placed in a jig 300 and adhesion-resistant coating may be applied to the mold 305. A conductive electrode sublayer may be deposited in the mold 310. Insulating sublayer may be deposited 315, followed by composite dielectric sublayer 320, and another insulating sublayer 325. All of the deposited sublayers may be bonded to form a single layer 330. The conductive sublayer may have a conducting contact tab on one side that extends beyond the edges of subsequently deposited sublayers on one side only. A determination is made whether there are sufficient bonded layers to form a capacitor 335. If not, operations 305-330 may be repeated to form one or more additional bonded sublayers. If a determination is made that there are enough bonded sublayers to forma capacitor 335, optionally a conductive layer may be added 340. The layers may be removed from the jig and all layers and surfaces of the stacked sets of bonded layers may be sealed in an electrically insulating material, leaving only the conducting contact tabs exposed 345. All exposed conducting contact tabs on one side of the capacitor are electrically connected with each other via a contact electrode. Similarly, all exposed conducting contact tabs on the other side of the capacitor may be electrically connected to one another via a contact electrode 350. Components and surfaces may be encased in an insulating material that leaves the lead electrodes exposed 355, thereby ending the manufacturing of a capacitor 360.

Referring to FIGS. 2 and 3, it is understood that the release of the unfinished capacitor part from the jig and/or mold, as described in steps 235 and 345, may be accomplished by applying upward force to an embossing stamp, potentially in combination with vibration or other processes.

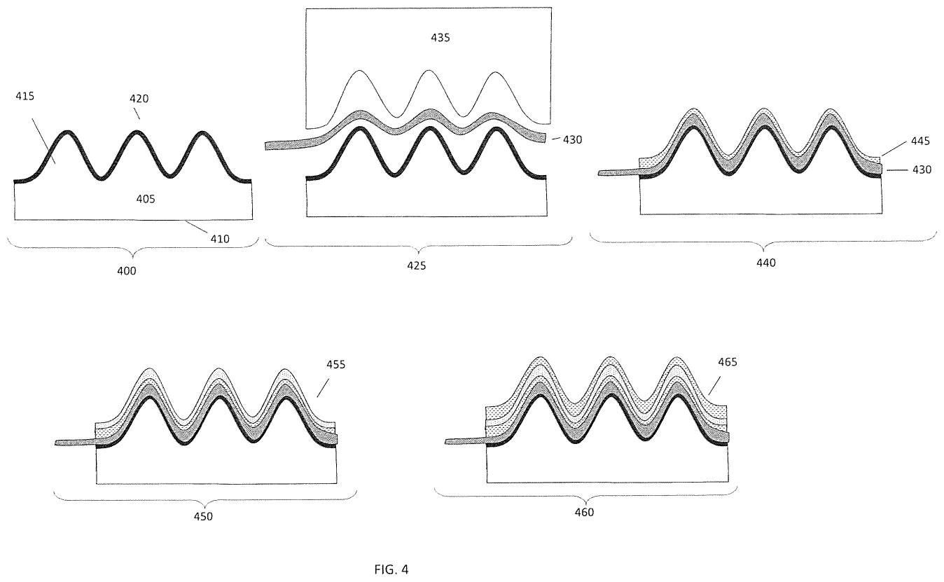

FIG. 4 illustrates some of the operations in FIG. 2 and/or FIG. 3 with greater detail. FIG. 4 shows a mold in the method used to build the apparatus. In operation 400 corresponding to operations 200 and 205 of FIG. 2, a jig (not shown) contains a mold viewed in cross-section 405, with the mold having a flat bottom face 410 and a face having an undulating top surface 415. Corresponding to operation 205 in FIG. 2, a non-adhesive coating 420 has been applied to the undulating top surface 415 of mold 405. Non-adhesive coating 420 may be made of polymer. In some embodiments, non-adhesive coating 420 may be a fluid. In operation 425 (corresponding to operation 210 of FIG. 2), a conducting film 430 is placed on the coated mold and an embossing stamp 435 is used to propagate the mold undulating pattern on the conducting film 430. In operation 440 (corresponding to operation 215 of FIG. 2), an insulating sublayer 445 is deposited, for example, with spinning of a solution onto conducting sublayer 430, followed by drying. In operation 450 (corresponding to operation 220 of FIG. 2), a dielectric sublayer 455 is deposited for example, with spinning of a solution onto insulating sublayer 445, followed by drying. The dielectric sublayer may be a composite, for example MXene in poly (vinylidene fluoride). In operation 460 (corresponding to operation 225 of FIG. 2), an insulating sublayer 465 is deposited for example, with spinning of a solution onto dielectric sublayer 455, followed by drying. These steps may be repeated, as illustrated in FIGS. 2 and 3.

In some embodiments, the sublayers and mold top surface 415 have patterns according to an equation Z=A*(sin(B*x)+sin(B*y)), where A is the amplitude, and 2*Pi/B is the period of the sine wave, forming a surface which resembles the undulating surface of egg crate foam. It is understood that A may between 2 and 10 times the period, in order to obtain a high aspect ratio, and that B may be between 2 and 50 microns. The use of a sine wave formula is for illustration. In some embodiments, another smooth surface is prescribed that is not a sine wave, for example an exponential.

Insulating sublayer may be a polymer, for example, poly (vinylidene fluoride) or polyimide. In an embodiment, insulating sublayer 445 and/or insulating sublayer 465 may be omitted. In an embodiment, insulating sublayer 445 and/or insulating sublayer 465 may be less than 5 microns or less than one micron in thickness. In an embodiment, dielectric material sublayer 455 is composed of a composite material, having an insulating material with a polymer phase [e.g., poly (vinylidene fluoride), or “PVDF”] which is fluid at under the conditions of deposition, and a dielectric material as a solid phase component. In an embodiment, said dielectric material may have a high dielectric constant (e.g., more than 100) which is dispersed in the fluid phase of the insulating material as a particulate. In an embodiment, said insulating material may have a high dielectric strength (e.g., more than 100 kV/mm).

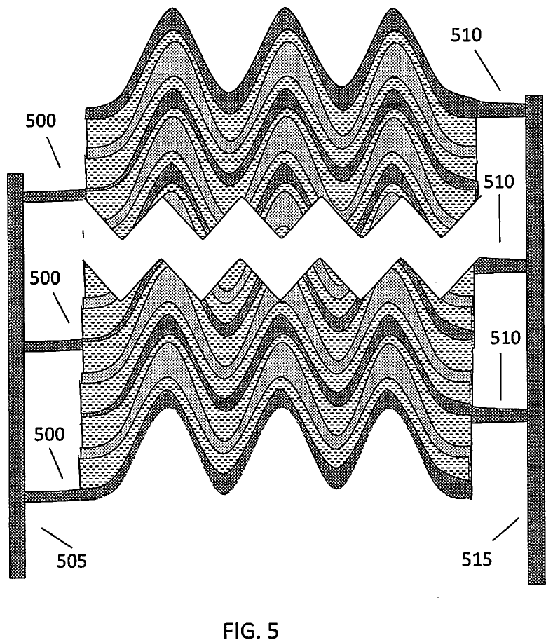

FIG. 5 illustrates how the layers constructed one, each layer comprising a sub-capacitor, may be assembled into a capacitor. The positions of the conducting tabs 500 and 510 alternate between layers. A terminal electrode post 505 may connect a fraction (e.g., half) of electrical contact tabs (i.e., tabs 500), and at least one additional terminal electrode post 510 may connect another fraction (e.g., half) of electrical contact tabs (i.e., tabs 510). Although FIG. 5 shows posts on opposite sides of the capacitor for illustrative purposes, and only shows two posts, it is understood that many such posts may be used (at varying positions) and connected appropriately (e.g., in parallel) to reduce overall resistance and/or inductance.

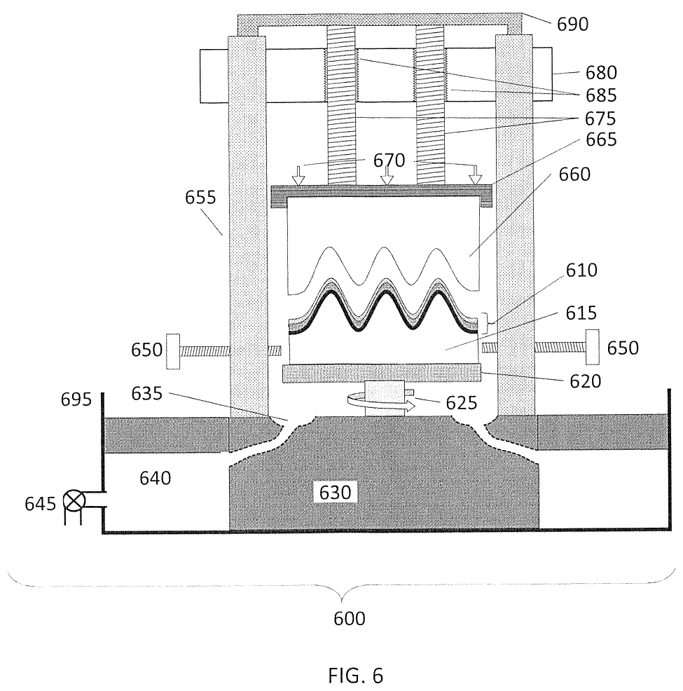

FIG. 6 illustrates a manufacturing apparatus 600 for constructing a capacitor. The capacitor is shown in an unfinished state, with various layers 610 atop mold 615. Mold 615 and incomplete capacitor 610 sit on a stage 620 that may be rotated via spindle 625 and heated under computer control computer. Spindle 625 may be actuated by a motor. The motor may be located in a support base 630. Support base 630 may have fluid drain port 635 draining into reservoir 640, with release valve 645. The rotation angle of the mold 615 may be registered and locked by mold set screws 650, which may be automated, threaded though vertical support pillars 655. The process of embossing may be performed by pressing embossing stamp 660 held with chuck 665 that may contain a non-adhesive layer. Embossing stamp 660 may be pressed into the incomplete capacitor by downward pressure 670 applied by drive screws 675. Drive screws 675 may be guided by drive screw guidance block 680, which contains drive screw guidance threading 685. Drive screws 675 may be controlled by the driver block 690 which contains precision motors under computer control for fine control of drive screw 675 rotation angle. In some embodiments, the support base 630 sits in a manufacturing basin 695.

In some embodiments, the physical features of the layers and sublayers may be imposed using one or more molds 405 and stamps 660. Said molds and stamps may be fabricated using 3D-printing technologies, for example two photon polymerization (2PP).

It is understood that the term “electrically conductive” or “electrically conducting” as applied to a layer or sublayer means that at least some of the material in the layer of sublayer has electrical conductivity greater than one million siemens per meter (if the material is a metal) or having conductivity greater than 10,000 siemens per meter (if the material is a polymer).

It is understood that the ability to withstand high voltage improves when sharp transitions are avoided, as taught by S. S. Swayamprabha et al in the 2018 Materials publication entitled “An Approach for Measuring the Dielectric Strength of OLED Materials”. Therefore, disclosed embodiments may have a smooth undulating curve along the surfaces of the sublayers. A metric for smoothness presented by Swayamprabha et al is the invert of the root mean square of roughness (“RMS roughness”). According to this publication, the dielectric strength of materials is inversely to the RMS roughness. For the purpose of this disclosure, the RMS roughness may be less than 1 nanometers, or less than 5 nanometers, or less than 10 nanometers, or less than 100 nanometers, or less than 1 micron, or less than 10 microns, or less than 100 microns, or less than 200 microns.

It is understood that the means of deposition of various sublayers may be as a fluid (e.g., from a nozzle) and that the mold may be rotated to make the fluid sublayer more uniform, and that heat or other processing operations (e.g., light, pressure, vibration) may be applied to solidify the fluid. It is understood that the means of depositions of various sublayers may be as films (for example from rolled sheets). It is understood that the films may include several sublayers, for example, it may be possible to deposit a copper-covered plastic film that will serve as both an insulating and conductive layer. The film may include one or more adhesive layers. It is understood that the temperature of the mold and/or film may be modified to improve the fidelity of the undulating pattern, for example by raising the temperature above the glass transition temperature for that film.

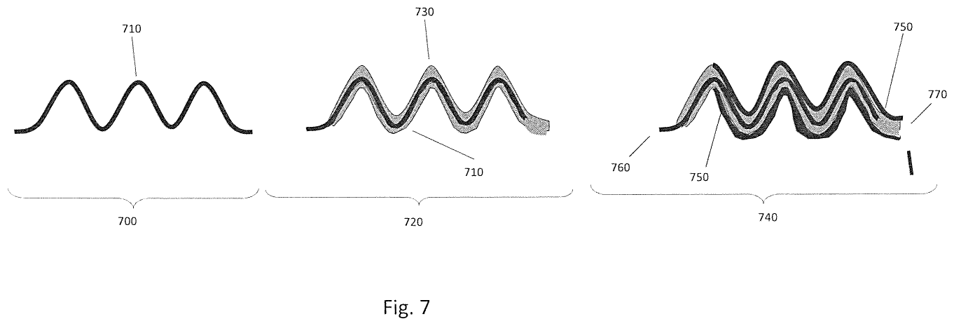

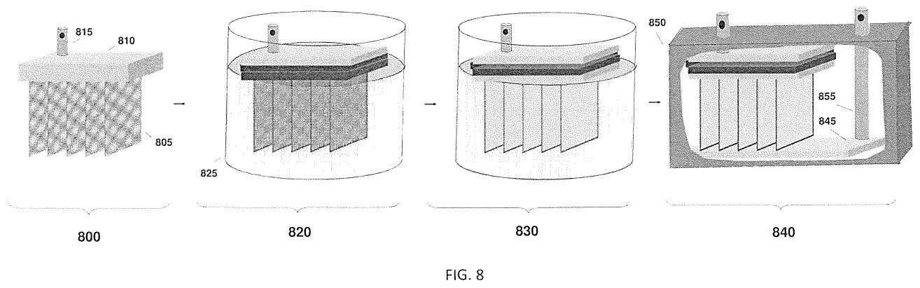

As shown in FIG. 7, in operation 700 a perforated conducting foil or wire mesh or micromesh 710 or other conducting material with gaps or holes or apertures (for example woven metal cloth, metal foam) is held in place by a holder or block (subsequently described in FIGS. 8). In operation 720 a dielectric 730 is partially deposited onto the mesh 710, so that part of the conducting foil 710 is not covered with dielectric and can therefore serve as a contact. In operation 740, a conducting material 750 is partially deposited on dielectric 730, so that the sub-capacitor may now be contacted and fastened at ends 760 and 770 to other components. For the purposes of this disclosure, a micromesh is defined as a material composed of wires or threads, where the gaps between the wires or threads is no larger than 100 microns.

FIG. 7 is meant to illustrate the principle in which successive depositions of dielectric and conductor in a sub-capacitor may partially overlap in order to establish contact regions for the sub-capacitor to be connected with other sub-capacitors. It is understood that other embodiments may utilize similar methods of partial overlap. It is understood that the perforated components 705 may be in the form of sheets as illustrated or may be spirals of perforated material or other types of materials, so long as it is possible for the perforations to be penetrated by fluids (for example dielectrics in subsequent steps). For the purposes of this disclosure, the term “aspect ratio” for a perforated material with holes is defined as the largest dimension of the holes divided by the smallest dimension of the holes.

The method begins in panel 800 by attaching conductive micromeshes 805 (for example, attaching by dip soldering) to a conductive block 810 (in an embodiment with a contact post 815) to form a working part, where we define a “working part” as a partially-completed apparatus. In operation 820, said working part is placed in container 825. Electrolyte is added so that the working part is partially submerged in an electrolyte-containing solution (for example, acidic titanium trichloride), and deposition of a dielectric layer commences to cover the conducting surface of the micromesh material as well as a portion of the conductive block 810 with a coating (for example, titanium dioxide). For purposes of illustration, the coated surface is shown in black. In subsequent operation 830, the electrolyte fluid has been drained and replaced with a fluid capable of depositing a conductive material (for example, a copper salt), with container 825 filled to a level below the prior electrolyte level, so that the new conductive material is not in electrical contact with the conductive block 810. For purposes of illustration, the conductor-covered surface is shown in gray. In operation 840, the lower portion of the assembly is attached to conducting block 845 with contact (for example, attaching via dip soldering), and then the assembly is coated in insulating material 850 (“potted”) with the exception of capacitor contact posts 815 and 855. Material 850 is shown with a cut-out section to illustrate internal contents of the capacitor, although in reality the cut-out section would be filled with material 850.

It is understood that the conducting block 810 may have additional features to aid in manufacturing, for example the block may have an insulating or fluid-impermeable ring around it, or internal conducting features so that the posts may be at different locations than as shown in FIG. 8. Although the method illustrated in FIG. 8 describes fluids at different heights in a container being used to differentially coat components of the capacitor, it is understood that other techniques (for example, masking portions of the components and exposing the unmasked portions to gaseous forms of materials such as dielectrics or conductors) may accomplish similar aims. It is understood that nozzles or other deposition tools (such as are used in 2-D or 3-D printers) may be used to create patterns of dielectric coatings and/or conducting materials, in addition to or instead of the submergence method shown in FIG. 8.

It is understood that a principle of the method shown in FIG. 8 is that the conducting edges of the sub-capacitors are on different locations of the sub-capacitors to enable assembly during manufacturing.

It is understood that for reasons of stability during the manufacturing process, perforated and/or sacrificial layers with insulating and/or high dielectric constant properties (e.g., dielectric strength >1 kV/cm and/or dielectric strength >100) may be placed between micromeshes 805.

It is understood that the deposition of various materials (for example, dielectrics or conductors) may be accomplished without moving the working part, for example by utilizing multiple electrodes for deposition and activating said electrodes at different times. For example, chamber 825 may have an anode and a counter electrode (for example, a cathode) and a reference electrode. In an embodiment, the base electrode (for example, an anode) is inserted into one chamber and the counter-electrode (cathode) is housed in a separate chamber and the working part may be in one of these chambers or in another chamber, such that one or more of the chambers are connected by a semi-permeable membrane that allows for ion exchange, as taught in Enrodi et al. in the publication entitled “One-Step Electrodeposition of Nanocrystalline TiO₂ Films with Enhanced Photoelectrochemical Performance and Charge Storage”, published in ACS Applied Energy Materials, in 2018.

In some embodiments, the dielectric deposited onto the perforated material 805 is titanium dioxide (TiO₂) or a TiO₂-based material (e.g., doped TiO₂ or a TiO₂-based compound). Titanium dioxide was first described as having colossal permittivity properties by L. Nicolini in 1952 in the publication entitled “A new dielectric material”, published in Nature, volume 170, in 1952. Recently, renewed interest in characterizing and explaining the colossal permittivity of TiO₂ has further detailed the mechanisms of permittivity, as demonstrated in the publication by Z. Peng et al., entitled “Understanding the ultrahigh dielectric permittivity response in titanium dioxide ceramics”, published in Ceramics International in 2020; the publication by C. C. Homes and T. Vogt, entitled “Doping for superior dielectrics”, published in Nature Materials in 2013; and the publication by C. C. Homes, T. Vogt, S. M. Shapiro, et al., entitled “Optical Response of High-Dielectric-Constant Perovskite-Related Oxide”, published in Science in 2001. Numerous TiO₂-based materials demonstrating large (“colossal”) permittivities have been documented in the literature, including TiO₂ doped with niobium and indium (as documented in the publication entitled “Colossal dielectric permittivity in hydrogen-reduced rutile TiO₂ crystals” by J. Li et al., published in the Journal of Alloys and Compounds in 2017), TiO₂ doped with scandium and tantalum (as documented in the publication entitled “Tuning enhanced dielectric properties of (Sc₃+-Ta₅+) substituted TiO₂ via insulating surface layers”, by W. Tuichai et al., published in Scientific Reports in 2024), and CaCu₃Ti₄O₁₂ materials (as documented in the publication entitled “High Dielectric Constant in ACu₃Ti₄O₁₂ and ACu₃Ti₃FeO₁₂ Phases”, by M. A. Subramanian et al., published in the Journal of Solid State Chemistry in 2000).

In some embodiments, TiO₂-based materials are deposited onto the perforated material 805 by submerging the material into an electrolyte containing ions for electrodeposition of TiO₂-based materials. One such electrolyte is a 50 mM TiCl₃ solution in 10% aqueous hydrochloric acid, pH adjusted to 2.5 via addition of 10% Na₂CO₃ solution, as taught by K. Wessels et al. in the publication entitled “Low-Temperature Preparation of Crystalline Nanoporous TiO2 Films by Surfactant-Assisted Anodic Electrodeposition”, published in Electrochemical and Solid-State Letters in 2006.

It is understood that the compositions, concentrations, temperatures, and other conditions of electrolyte and conducting solutions or deposition materials may be varied during the process shown in FIG. 8. For example, electrolytes with different dopants may be used during production of a single capacitor. The coating thicknesses of the electrolytes may be as thin as several nanometers, as thick as 10 nanometers, or as thick as 1 micron, or as thick as 10 microns. The coating thicknesses of the conducting materials may be as thin as several nanometers, as thick as 10 nanometers, or as thick as 1 micron, or as thick as 10 microns.

It is understood that the processes of deposition illustrated in FIG. 8 may be among the following: electroplating, electroless plating, spray-coating, physical or chemical vapor means,

It is understood that the method illustrated in FIG. 8 may include intermediate steps such as sintering. Sintering may take place in an oxygen-rich environment or may take place in an inert gas environment. In one embodiment of the invention, dopant materials are deposited either before or after the TiO₂-based materials. In such an embodiment, the dopant materials may be incorporated into the thickness of the TiO₂-based material layer by subsequent thermal processing.

It is understood that conducting block 810 may have features that are beneficial to attach to the perforated sheets, or beneficial for improving performance of the capacitor (for example a roughened surface to increase capacitance). For example, an RMS roughness of less than 100 microns.

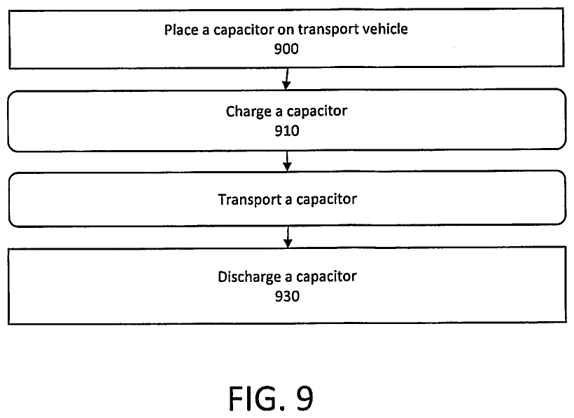

FIG. 9 of the disclosed embodiments describes an embodiment of the method of energy transport. At least one capacitor is placed in a transport vehicle 900. The capacitor may be charged before placement, or after placement as in operation 910 to a high voltage, for example above 1 kV. The at least one capacitor is transported by the vehicle to a distribution point or to the consumer 920. The capacitor may be completely or partially discharged to the consumer or a distribution point removal from the vehicle (as in step 930), or after removal from the vehicle. The capacitor may be completely or partially charged before removal from the vehicle.

It is understood that one rationale of the disclosed embodiments is to avoid placing or using transmission lines where it is inconvenient or impossible, by transporting energy (in the form of charged capacitors) from one location to another. The disclosed embodiments may be used to avoid placing or using sections of transmission lines.

In some embodiments, the dielectric sublayer of Capacitor may be a composite, for example MXene in poly (vinylidene fluoride). A calculation of the capacitance of the capacitor in the disclosed embodiments, based on the physical dimensions and electrical characteristics of the sublayers, results in an estimate of 100 microfarads per cubic centimeter. A calculation of the capacitor's breakdown voltage, based on the physical dimensions and electrical characteristics of the sublayers, is 5,000 volts. The energy density of such a Capacitor may therefore be estimated (using the equation for energy in a capacitor: 0.5*C*V*V) as 1,250 joules per cubic centimeter, or more than 1 megajoule/cubic meter.

It is understood the capacitor's breakdown voltage may be varied by increasing the thickness of the dielectric sublayer of the Capacitor, thereby constituting a new apparatus. With a thickness of 200 microns, the breakdown voltage of the Capacitor may be above 20 kV. With greater thickness, the breakdown voltage may increase to 30 kV or higher. At or about 20 kV, the energy density (in megajoules/kilogram) of the capacitor is comparable or higher to that of gasoline (i.e., about 40 MJ/kg). As is well known, gasoline is typically transported from the refinery or distribution point to localities where the gasoline is dispensed (“gas stations”).

It is understood that the invention may be advantageous in transporting and storing energy at stations for use by electric vehicles that themselves contain capacitors, since discharge of a capacitor into another capacitor may be much faster than charging a battery. The discharge time may be less than one second.

It is understood that the energy storage of the capacitor is so high (for example higher than oil) that the capacitors may be used to transport energy instead of using oil tankers or other means of transporting energy.

It is understood that the power storage (i.e., the energy storage divided by the discharge time) of the capacitor is so high (for example, higher than batteries) that the capacitors may be used to power directed energy devices.

It is understood that the power storage (i.e., the energy storage divided by the charging time) of the capacitor is so high (for example, higher than batteries) that the capacitors may be used to power electric vehicles.

Those skilled in the art will recognize, upon consideration of the above teachings, that the above exemplary embodiments and the controls may be based upon use of one or more programmed processors programmed with a suitable computer program. However, the disclosed embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Moreover, it should be understood that control and cooperation of the above-described components may be provided using software instructions that may be stored in a tangible, non-transitory storage device such as a non-transitory computer readable storage device storing instructions which, when executed on one or more programmed processors, carry out he above-described method operations and resulting functionality. In this case, the term “non-transitory” is intended to preclude transmitted signals and propagating waves, but not storage devices that are erasable or dependent upon power sources to retain information.

Those skilled in the art will appreciate, upon consideration of the above teachings, that the program operations and processes and associated data used to implement certain of the embodiments described above can be implemented using disc storage as well as other forms of storage devices including, but not limited to non-transitory storage media (where non-transitory is intended only to preclude propagating signals and not signals which are transitory in that they are erased by removal of power or explicit acts of erasure) such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments. Such alternative storage devices should be considered equivalents.

Although the invention has been explained in relation to various embodiments, it is to be understood that many other possible modifications and variations can be made without departing from the spirit and scope of the invention.

1. An apparatus comprising:
a plurality of sub-capacitors, at least one of which having an undulation or perforation pattern, wherein the apparatus forms a capacitor, and
at least one of the plurality of sub-capacitors includes at least one sublayer of dielectric material and at least one electrically conducting material.

2. The apparatus of claim 1, wherein the undulation pattern or perforation pattern has an aspect ratio higher than 5.

3. The apparatus of claim 1, wherein the undulation pattern has an RMS roughness of less than 100 microns.

4. The apparatus of claim 1, wherein an insulating layer is present between sublayers or sub-capacitors.

5. The apparatus of claim 1, wherein at least one dielectric material sublayer includes MXene material.

6. The apparatus of claim 1, wherein at least one dielectric material sublayer includes titanium dioxide material.

7. The apparatus of claim 1, wherein at least one dielectric material sublayer includes doped titanium dioxide material.

8. The apparatus of claim 1, wherein the distance between conducting layers is less than 20 microns.

9. The apparatus of claim 1, wherein the largest dimension is more than 1 mm.

10. The apparatus of claim 1, wherein the breakdown voltage is more than 1,000 volts.

11. The apparatus of claim 1, wherein the breakdown voltage is more than 5,000 volts.

12. The apparatus of claim 1, wherein the energy per volume is more than 1,000,000 Joules per cubic meter.

13. The apparatus of claim 1, wherein the at least one dielectric material sublayer includes a dielectric material with a dielectric constant higher than 100.

14. The apparatus of claim 1, further comprising boost or step down circuits configured to attach the apparatus to a vehicle or a consumer of electricity.

15. The apparatus of claim 1, further comprising attachments to transport the apparatus to an energy consumer.

16. A method for manufacturing a patterned capacitor comprising
embossing layers of conductors and insulators,
forming stacks of the layers via the sequential application of pressure, applied over a 3D printed shape-defined mold having an undulation pattern.

17. An apparatus for manufacturing a patterned capacitor comprising:
at least one pressure controlled motorized embossing tool configured to press an embossing mold into a film surface for patterning films, wherein the apparatus is used to sequentially stack material films layer by layer for forming a capacitor.

18. A method for manufacturing a patterned capacitor comprising:
assembling perforated conducting materials into sub-capacitors by successively and partially coating the perforated conducting materials with electrolyte and additional conducting materials, wherein the sub-capacitors are assembled into a capacitor.

19. The method of claim 18, wherein a perforated or sacrificial insulating or electrolytic layer is placed between the perforated conducting materials to stabilize the assembly during manufacturing.

20. The method of claim 18, wherein conducting edges of the sub-capacitors are on different locations of the sub-capacitors to enable assembly during manufacturing.
